(19) United States
(12) Patent Application Publication
(10) Pub. No.: US 2007/0204270 A1
(43) Pub. Date: Aug. 30, 2007

(54) Apparatus and method for processing operations of nonvolatile memory in order of priority

(75) Inventor: Dong-kun Shin, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/656,534

(22) Filed: Jan. 23, 2007

(30) Foreign Application Priority Data
Feb. 28, 2006 (KR) 10-2006-0019539

(51) Int. Cl. G06F 9/46

(52) U.S. Cl. 718/103

(57) ABSTRACT

Provided are an apparatus and method for processing operations of a nonvolatile memory in order of priority, more particularly, an apparatus and method for processing operations of a nonvolatile memory in order of priority, the apparatus and method capable of reducing response time and preventing frequent stops and resumptions of an operation. The apparatus includes a first time calculation unit calculating the time remaining until a deadline for a second job when the second job with a higher priority than a first job is requested while a first operation is performed as the first job is executed; a second time calculation unit calculating a remaining operation time of the first operation and a remaining execution time of the second job; and a control unit determining whether to stop the first operation by comparing the times calculated by the first time calculation unit and the second time calculation unit.

### CROSS-REFERENCE TO RELATED APPLICATION

This application claims priority from Korean Patent Application No. 10-2006-0019539 filed on Feb. 28, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to processing operations of a nonvolatile memory in order of priority, and more particularly, to processing operations of a nonvolatile memory in order of priority, reducing response time, and preventing frequent stops and resumptions of an operation.

2. Description of the Related Art

Generally, nonvolatile memories are widely used in embedded systems, such as electric home appliances, communication devices and set-top boxes, as storage media for storing and processing data.

Flash memories, which are one of the most widely used nonvolatile memories, are nonvolatile memory devices that can electrically erase or rewrite data. Flash memories consume less power than storage media based on magnetic disk memories and have access time as fast as hard disks. In addition, since flash memories are small, they are suitable for handheld devices.

Flash memories have writing, reading and erasing operations and have hardware characteristics in which a block must be erased before data is written to the block. It usually takes a very long time for a flash memory to perform the erasing operation as compared with the writing and reading operations. Worse, it takes even longer for the flash memory to simultaneously erase a number of blocks, or read or write several pages at a time.

A real-time system using a flash memory has operations with various priorities. When some operations are requested of the system, the requested operations are arranged in an operation queue in order of priority. Before the operations in the operation queue are performed, the system transmits information needed for command and execution to the flash memory through a flash translation layer so that the flash memory can perform the operations.

While performing an operation, if another operation with a higher priority is requested, the flash memory keeps the operation with the higher priority on standby until the operation currently being performed is completed. In this case, since the operation with the higher priority is kept on standby until the operation currently being performed is completed, a response time of the real-time system is slow. Moreover, if the operation currently being performed by the real-time system is the erasing operation, which requires a longer time as compared with the reading and writing operations, the response time of the system becomes slower, which results in performance deterioration of the real-time system.

To prevent an increase in the response time of the real-time system, when the operation with the higher priority is requested while performing the current operation, the real-time system may stop performing the current operation and perform the operation with the higher priority. In addition, when the operation with the higher priority is completed, the real-time system may resume the stopped operation. In this way, the real-time system can reduce response time. In this case, a predetermined operation stop time for stopping the operation and a predetermined operation resumption time for resuming the stopped operation are required.

FIG. 1 is a diagram illustrating a conventional process of performing operations in order of priority.

Referring to FIG. 1, while performing an operation with a low priority as a job with a low priority is executed, if a nonvolatile memory is requested to perform an operation with a high priority as a job with a high priority is executed, the nonvolatile memory stops performing the operation with the low priority and performs the operation with the high priority.

In this case, the operation with the low priority, which was stopped to perform the operation with the high priority, is nullified and performed again from the beginning after the operation with the high priority is completed. Here, since there is sufficient time left before the deadline set for the job with the high priority, the operation for the job with the high priority can still be performed without any problem even if the operation for the job with the low priority is not stopped.

However, while performing the operation with the low priority, if the nonvolatile memory is requested to perform the operation with the high priority as the job with the high priority is executed, the nonvolatile memory stops the operation with the low priority unconditionally. Therefore, if the operation with the low priority is the erasing operation, the lifetime of the nonvolatile memory can be reduced due to too frequent erasing operations.

Japanese Patent Publication No. 1998-177563 discloses a built-in microcomputer which stops a clock generation unit from supplying clocks to a central processing unit (CPU) in response to an output signal of a flash control circuit while a flash memory is written or erased. The conventional art is designed to prevent an overload that occurs since the CPU frequently polls the completion of writing and erasing operations while the flash memory performs the writing and erasing operations. However, the conventional art fails to suggest a method of preventing an increase in response time and a decrease in the lifetime of a real-time system using a flash memory when the real-time system is requested to perform an operation with a higher priority while performing another operation.

### SUMMARY OF THE INVENTION

The present invention provides an apparatus and method for processing operations of a nonvolatile memory in order of priority, the apparatus and method capable of reducing response time and preventing a reduction in the lifetime of the nonvolatile memory by determining whether to stop an operation being performed as a job with a low priority is executed when a job with a high priority is requested in consideration of a deadline for the job with the high priority.

However, aspects of the present invention are not restricted to those set forth herein. The aspects of the present invention will become more apparent to one of daily skill in the art to which the present invention pertains by referencing a detailed description of exemplary embodiments of the present invention given below.

According to an aspect of the present invention, there is provided an apparatus for processing operations of a nonvolatile memory in order of priority. The apparatus includes a first time calculation unit calculating the time remaining until a deadline for a second job when the second job with a higher priority than a first job is requested while a first operation is performed as the first job is executed; a second time calculation unit calculating a remaining operation time of the first operation and a remaining execution time of the second job; and a control unit determining whether to stop the first operation by comparing the times calculated by the first time calculation unit and the second time calculation unit.

According to another aspect of the present invention, there is provided an apparatus for processing operations of a nonvolatile memory in order of priority. The apparatus includes a job request expectation unit determining whether a request for a second job with a higher priority than a first job is expected while a first operation is performed as the first job is executed; an operation delay unit delaying the first operation and performing a second operation as the second job is executed if the job request expectation unit determines that the request for the second job is expected; and a control unit performing the delayed first operation after the second operation is completed.

According to still another aspect of the present invention, there is provided a method of processing operations of a nonvolatile memory in order of priority. The method includes calculating the time remaining until a deadline for a second job when the second job with a higher priority than a first job is requested while a first operation is performed as the first job is executed; calculating a remaining operation time of the first operation and a remaining execution time of the second job; and determining whether to stop the first operation by comparing the times calculated by the first time calculation unit and the second time calculation unit.

According to still another aspect of the present invention, there is provided a method of processing operations of a nonvolatile memory in order of priority. The method includes determining whether a request for a second job with a higher priority than a first job is expected while a first operation is performed as the first job is executed; delaying the first operation and performing a second operation as the second job is executed if it is determined that the request for the second job is expected; and performing the delayed first operation after the second operation is completed.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram illustrating a conventional process of performing operations of a nonvolatile memory in order of priority;

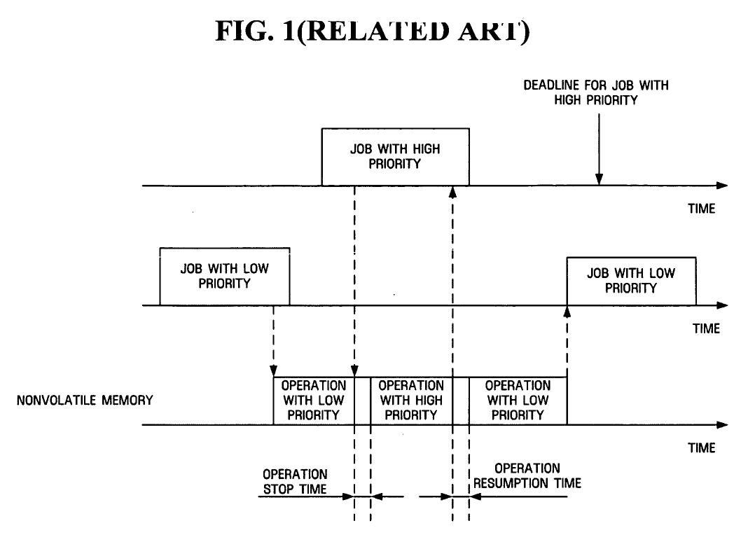

FIG. 2 is a block diagram of an apparatus for processing operations of a nonvolatile memory in order of priority according to a first exemplary embodiment of the present invention;

FIG. 3 is a block diagram of an apparatus for processing operations of a nonvolatile memory in order of priority according to a second exemplary embodiment of the present invention;

FIG. 4 is a flowchart illustrating a method of processing operations of a nonvolatile memory in order of priority according to the first exemplary embodiment of the present invention;

FIG. 5 is a diagram illustrating a process of performing a second operation after a first operation is completed according to an exemplary embodiment of the present invention;

FIG. 6 is a flowchart illustrating a method of processing operations of a nonvolatile memory in order of priority according to the second exemplary embodiment of the present invention; and

FIG. 7 is a diagram illustrating a process of delaying the first operation until the second operation is completed.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and thus their description will be omitted.

Hereinafter, an apparatus and method for processing operations of a nonvolatile memory in order or priority according to exemplary embodiments of the present invention will be described with reference to block diagrams or flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

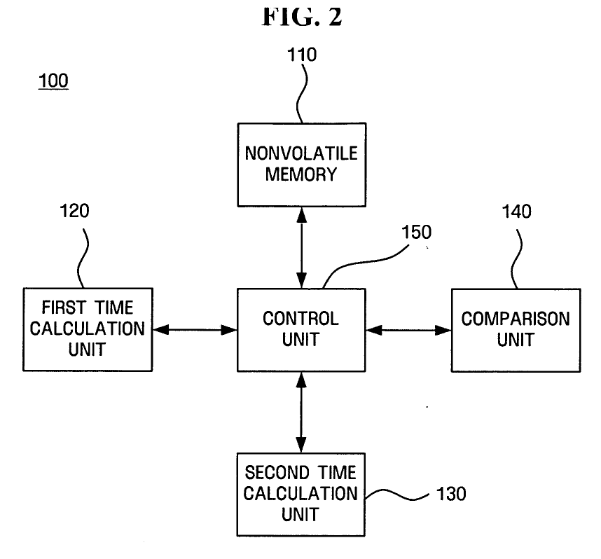

FIG. 2 is a block diagram of an apparatus 100 for processing operations of a nonvolatile memory 110 in order of priority according to a first exemplary embodiment of the present invention.

Referring to FIG. 2, the apparatus 100 may include the nonvolatile memory 110, a first time calculation unit 120, a second time calculation unit 130, a comparison unit 140, and a control unit 150.

While performing an operation with a low priority as a job with a low priority is executed, if the nonvolatile memory 110 is requested to perform a job with a high priority, the first time calculation unit 120 may calculate the time remaining until the deadline for the job with the high priority.

The term ‘job’, as used in the exemplary embodiments of the present invention, may denote an application program executed in response to a user's command. Such an application program can access the nonvolatile memory 110 and perform an operation when necessary, depending on a process. Therefore, the job may or may not include an operation performed by the nonvolatile memory 110 or may be the operation itself.

In the first exemplary embodiment of the present invention, a job with a low priority will be referred to as a first job, and a job with a high priority will be referred to as a second job. In addition, operations performed as the first and second jobs are executed will be referred to as first and second operations, respectively.

The time remaining until the deadline for the second job, which is calculated by the first time calculation unit 10, may be understood as the time left before the time allocated to the second job ends. The second job must transmit a response to a host before the deadline. The time allocated to a job may vary according to the type of the job and the type of an operation that is performed as the job is executed. For example, when an operation performed as a job is executed is a writing operation, a shorter time is allocated than when the operation is an erasing operation. This is because the erasing operation requires a longer time than the writing operation.

In an exemplary embodiment of the present invention, the time remaining until the deadline for the second job may also be understood as the time extending from when the second operation is requested as the second job is executed to when the time allocated to the second job ends.

The second time calculation unit 130 may calculate a remaining operation time of the first operation being performed by the nonvolatile memory 110 and a remaining execution time of the second job when the second operation starts.

An operation time of an operation may be determined by the type and size of the operation, and the remaining operation time of an operation may be the difference between the operation time of the operation and the time that passed after the operation started to be performed. In addition, a job execution time of a job may be determined by the type of the job and the type of an operation performed as the job is executed. The remaining execution time of a job may be the difference between the execution time of the job and the time extending from when the job starts to be performed to when the second operation starts. In the present exemplary embodiment, a case where the remaining execution time includes the operation time of the second operation that is performed as the second job is executed will be described as an example.

The comparison unit 140 may compare the time remaining until the deadline for the second job, which is calculated by the first time calculation unit 120, with a sum of the remaining operation time of the first operation and the remaining execution time of the second job, which are calculated by the second time calculation unit 130. In the first exemplary embodiment of the present invention, the time remaining until the deadline is indicated by T1, and the sum of the remaining operation time of the first operation and the remaining execution time of the second job is indicated by T2. The comparison unit 140 compares T1 with T2. The second operation can be performed after the first operation is completed in the case of T1>T2 since there is sufficient time left before the deadline for the second job. The second operation can be performed first while the first operation is stopped in the case of T1<T2 since there is no sufficient time left before the deadline for the second job.

The comparison performed by the comparison unit 140 is designed to secure a faster response time than a conventional method of unconditionally stopping an operation with a low priority when an operation with a higher priority is requested. The comparison performed by the comparison unit 140 is also designed to prevent overly frequent stops and resumptions of an operation performed by the nonvolatile memory 110, thereby preventing a reduction in the lifetime of the nonvolatile memory 110.

The control unit 150 may determine whether to stop the first operation based on the comparison result of the comparison unit 140. Specifically, if the comparison result of the comparison unit 140 indicates that T1>T2 since there is sufficient time left before the deadline for the second job, the control unit 150 can perform the second operation after completing the first operation. If the comparison result of the comparison unit 140 indicates that T1<T2 since there is no sufficient time left before the deadline for the second job, the control unit 150 stops the first operation and performs the second operation. Since a predetermined operation stop time is required in order to stop the first operation, the control unit 150 performs the second operation after the predetermined operation stop time. In addition, after the second operation is completed, the control unit 150 resumes the stopped first operation after a predetermined operation resumption time.

It can be understood that the apparatus 100 of FIG. 2 according to the first exemplary embodiment of the present invention cannot expect the second job with a higher priority than the first job to be requested while performing the first operation as the first job is executed. While performing the first operation as the first job is executed, if the apparatus 100 can expect the second job with the higher priority than the first job to be requested, it can perform the second operation first as the second job is executed while delaying the first operation for a predetermined period of time.

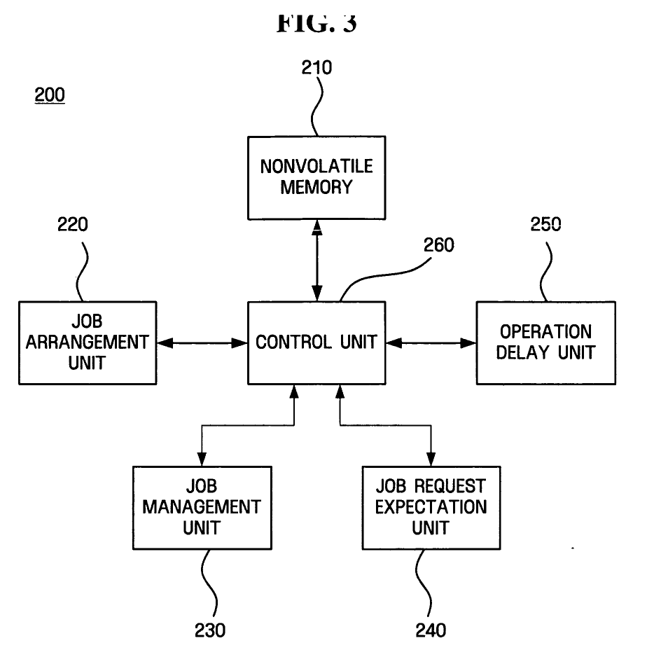

FIG. 3 is a block diagram of an apparatus 200 for processing operations of a nonvolatile memory 210 in order of priority according to a second exemplary embodiment of the present invention. The apparatus 200 illustrated in FIG. 3 will be described using, as an example, a case where a request for the second job with a higher priority than the first job can be expected while the first operation is performed as the first job is executed.

Referring to FIG. 3, the apparatus 200 may include the nonvolatile memory 210, a job arrangement unit 220, a job management unit 230, a job request expectation unit 240, an operation delay unit 250, and a control unit 260.

The job arrangement unit 220 may arrange a plurality of jobs in order of priority. Here, the job arrangement unit 220 may not only arrange previously requested jobs but also rearrange the arranged jobs in consideration of the priority of a newly requested job.

The job management unit 230 may determine whether the operation times of operations performed as the jobs arranged by the job arrangement unit 220 are executed overlap one another. Specifically, when a new job is requested while the jobs arranged by the job arrangement unit 220 are executed in an arrangement order, the job arrangement unit 220 may rearrange the jobs in consideration of the priority of the newly requested job. Here, the job arrangement unit 220 also determines whether an operation performed as the newly requested job is executed overlaps an operation being performed.

Based on the determination result of the job management unit 230, the job request expectation unit 240 may determine whether a request for a job with a high priority is expected while an operation with a low priority is performed as a job with a low priority is executed. Specifically, when the first operation is performed as the first job with the low priority is executed, the job management unit 230 determines whether the second job with the high priority is expected and whether the second operation performed as the second job is executed overlaps the first operation. In this case, the job request expectation unit 240 may determine whether the operation time of the second operation performed as the second job is executed overlaps the operation time of the first operation based on the determination result of the job management unit 230.

If the job request expectation unit 240 determines that the second operation performed as the second job is executed overlaps the first operation, the operation delay unit 250 delays performing the first operation as the execution of the first job is executed. Hence, if the first operation is the erasing operation and the second operation is the writing operation, the first operation can be prevented from being stopped. Consequently, a reduction in the lifetime of the nonvolatile memory 210 caused by repeated erasing operations of the nonvolatile memory 210, which are due to the frequent stops of the first operation, can be prevented.

When the first operation performed as the first job is executed is delayed by the operation delay unit 250, the control unit 260 may allow the first operation to be performed after the second operation is completed.

The apparatus 200 illustrated in FIG. 3 has been described above using, as an example, a case where the request for the second job with the high priority can be expected while the first operation is performed as the first job with the low priority is executed. However, the present invention is not limited thereto. When there is no sufficient time left before the deadline for the second job, the apparatus 200 can delay the first operation and perform the second operation first, thereby preventing missing the deadline for the second operation.

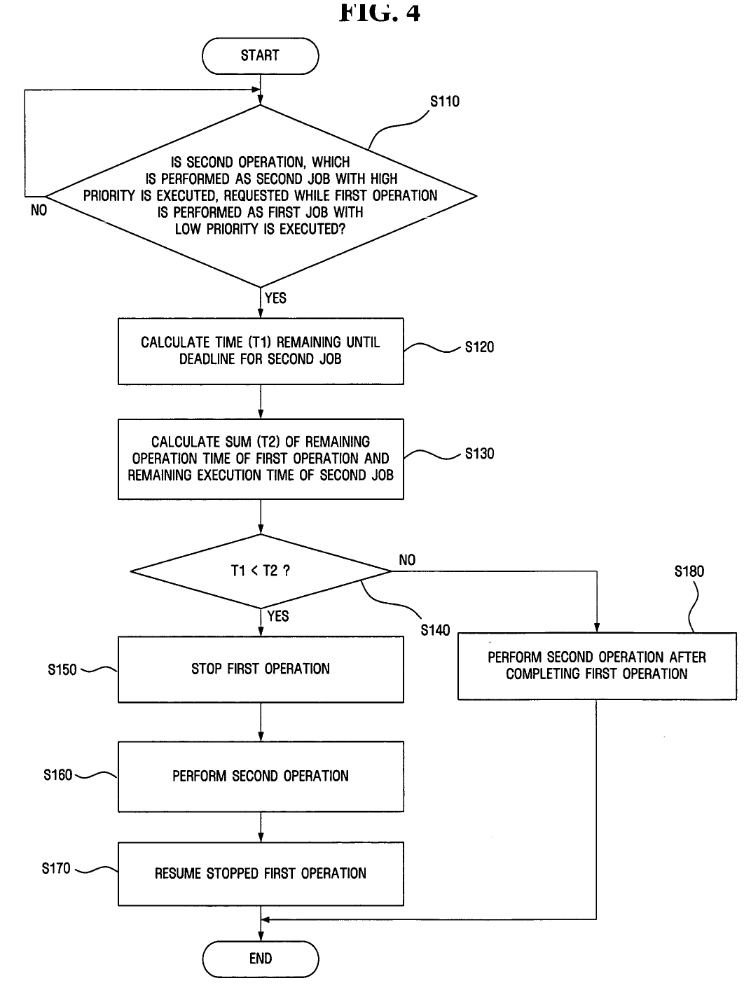

FIG. 4 is a flowchart illustrating a method of processing operations of a nonvolatile memory in order of priority according to the first embodiment of the present invention. The method illustrated in FIG. 4 may be understood as the operation of the apparatus 100 illustrated in FIG. 2.

Referring to FIG. 4, the control unit 150 determines whether the second operation with a higher priority than the first operation has been requested while the first operation is performed as the first job is executed (operation S110).

If the control unit 150 determines that the second job has been requested while the first operation is performed as the first job is executed, the first time calculation unit 120 calculates the time T1 remaining until the deadline for the second job (operation S120). The calculated time T1 remaining until the deadline for the second job may be understood as the time extending from when the second operation is started as the second job is executed to when the time allocated to the second job ends.

In addition, the second time calculation unit 130 calculates the remaining operation time of the first operation and the remaining execution time of the second job and calculates a sum T2 of the calculated remaining operation time of the first operation and the calculated remaining execution time of the second job (operation S130). An operation time of an operation may be determined by the type and size of the operation, and the remaining operation time of an operation may be the difference between the operation time of the operation and the time that passed after the operation started to be performed. In addition, the job execution time of a job may be determined by the type of the job and the type of an operation performed as the job is executed. The remaining execution time of a job may be the difference between the execution time of the job and the time extending from when the job starts to be performed to when the second operation starts. In the present exemplary embodiment, a case where the remaining execution time includes the operation time of the second operation that is performed as the second job is executed will be described as an example.

The comparison unit 140 compares T1 calculated by the first time calculation unit 120 with T2 calculated by the second time calculation unit 130 (operation S140).

As a result of the comparison of the comparison unit 140, if T2>T1, the control unit 150 stops the first operation (operation S150). In this case, the control unit 150 requires a predetermined operation stop time in order to stop the first operation.

In addition, after the operation stop time of the first operation passes, the control unit 150 performs the second operation as the second job is executed (operation S160) and resumes the first operation after completing the second operation (operation S170). In this case, the control unit 150 also requires an operation resumption time in order to resume the first operation.

If T1>T2 in operation S140, the control unit 150 performs the second operation after completing the first operation (operation S180).

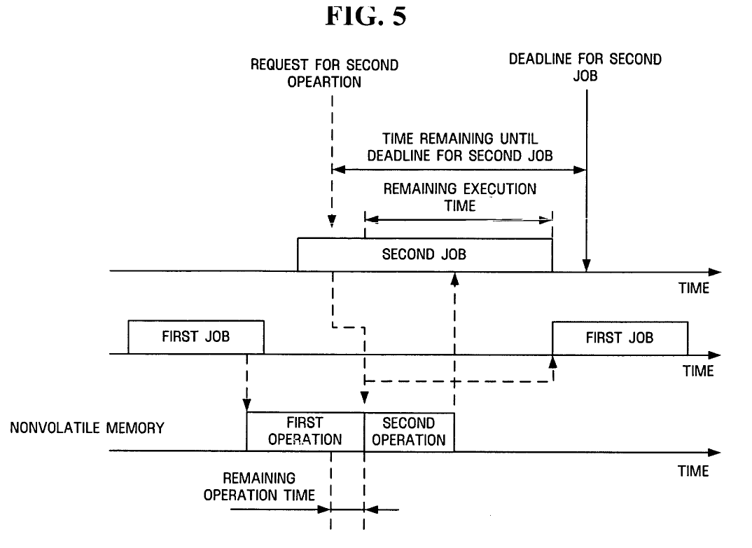

FIG. 5 is a diagram illustrating a process of performing the second operation after the first operation is completed according to an exemplary embodiment of the present invention.

Referring to FIG. 5, since the sum of the remaining operation time of the first operation and the remaining execution time of the second job is less than the time remaining until the deadline for the second operation, there is sufficient time left before the deadline for the second job. Therefore, the second operation can be delayed until the first operation is completed so that the second operation can be performed after the first operation is completed.

In FIG. 5, a response can be made within the time allocated to the second job even when the second operation is performed after the first operation is completed. Therefore, there is no need to stop the first operation. Consequently, the nonvolatile memory 110 can be prevented from repeatedly performing the first operation, and an increase in response time can be prevented.

Alternatively, if the sum of the remaining operation time of the first operation and the remaining execution time of the second job is greater than the time remaining until the deadline for the second operation in FIG. 5, there is no sufficient time left before the deadline for the second job. Therefore, the first operation is stopped and then the second operation is performed. Thereafter, if the second operation is completed, the stopped first operation is resumed. Consequently, a response can be made within the time allocated to the second job.

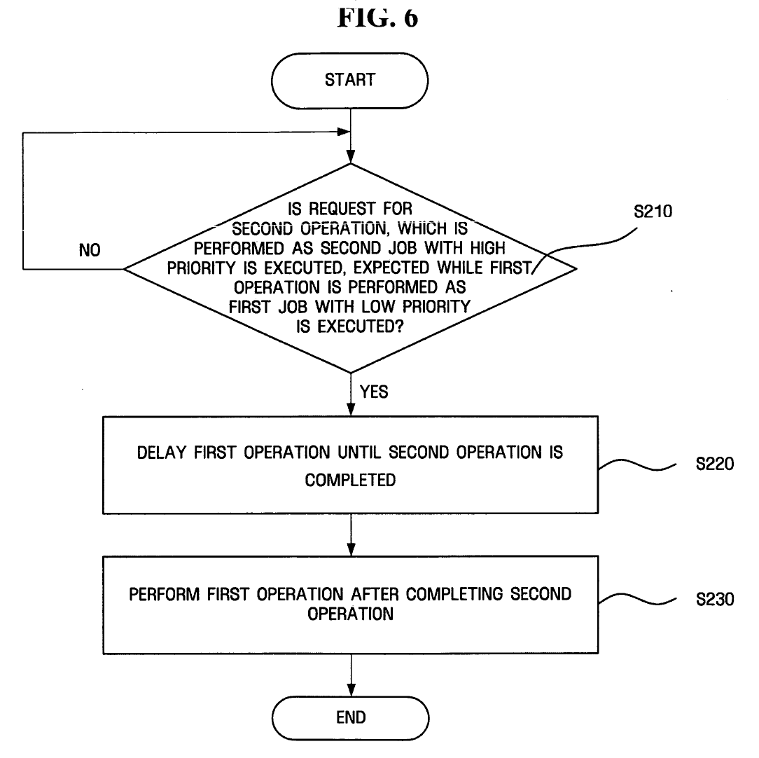

FIG. 6 is a flowchart illustrating a method of processing operations of a nonvolatile memory in order of priority according to the second exemplary embodiment of the present invention. The method illustrated in FIG. 6 may be understood as the operation of the apparatus 200 illustrated in FIG. 3.

Referring to FIG. 6, the job request expectation unit 240 determines whether a request for the second job with the high priority is expected while the first operation is performed as the first job with the low priority is executed (operation S210). In this case, the job request expectation unit 240 may receive the result of determination which the job management unit 230 made about whether the first operation overlaps the second operation based on the arrangement result of the job arrangement unit 220. The job request expectation unit 240 may also expect the request for the second job based on the determination result.

If the job request expectation unit 240 determines that the request for the second job is expected, the operation delay unit 250 delays the first operation performed as the first job is executed until the second operation is completed (operation S220).

The control unit 260 performs the first operation delayed by the operation delay unit 250 when the second operation is completed (operation S230).

The method of FIG. 6 has been described using, as an example, a case where the second job with the higher priority than the first operation is requested while the first operation is performed as the first job is executed. However, the present invention is not limited thereto. The method can also be used when the deadline for the second job is approaching.

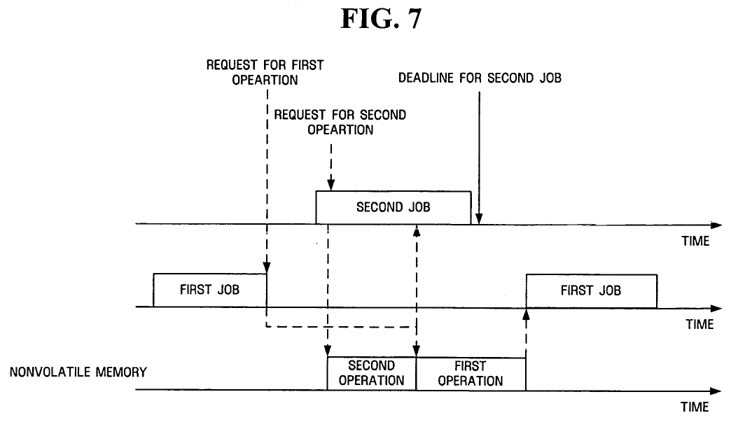

When the deadline for the second job is approaching as illustrated in FIG. 7, if the second operation is performed as the second job is executed and if the operation time of the second operation overlaps that of the first operation performed as the first job is executed, the second operation may be performed first while the first operation is delayed, and the first operation may be performed after the second operation is completed without comparing the deadline, the remaining operation time and the remaining execution time as illustrated in FIG. 5.

As described above, an apparatus and method for processing operations of a nonvolatile memory in order of priority can reduce response time and prevent overly frequent stops and resumptions of an operation with a low priority when an operation with a high priority is requested while performing the operation with the low priority.

The term ‘unit’, as used herein, means, but is not limited to, a software or hardware component, such as a Field Programmable Gate Array (FPGA) or Application Specific Integrated Circuit (ASIC), which performs certain tasks. A unit may be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for processing operations of a nonvolatile memory in order of priority, the apparatus comprising:
a first time calculation unit which calculates the time remaining until a deadline for a second job if the second job with a higher priority than a first job is requested while a first operation is performed as the first job is executed;
a second time calculation unit which calculates a remaining operation time of the first operation and a remaining execution time of the second job; and
a control unit which determines whether to stop the first operation by comparing the time calculated by the first time calculation unit and the time calculated by the second time calculation unit.

2. The apparatus of claim 1, further comprising a comparison unit which compares the time remaining until the deadline for the second job with the remaining operation time of the first operation and the remaining execution time of the second job.

3. The apparatus of claim 2, wherein, if the comparison unit determines that the time remaining until the deadline for the second job is greater than a sum of the remaining operation time and the remaining execution time, the control unit performs a second operation as the second job is executed after completing the first operation.

4. The apparatus of claim 3, wherein the control unit delays the second operation until the first operation is completed.

5. The apparatus of claim 2, wherein, if the comparison unit determines that the time remaining until the deadline for the second job is less than a sum of the remaining operation time and the remaining execution time, the control unit stops the first operation and performs the second operation as the second job is executed.

6. The apparatus of claim 5, wherein the control unit resumes the stopped first operation after the second operation is completed.

7. An apparatus for processing operations of a nonvolatile memory in order of priority, the apparatus comprising:
a job request expectation unit which determines whether a request for a second job with a higher priority than a first job is expected while a first operation is performed as the first job is executed;
an operation delay unit which delays the first operation and performs a second operation as the second job is executed if the job request expectation unit determines that the request for the second job is expected; and
a control unit which performs the delayed first operation after the second operation is completed.

8. The apparatus of claim 7, further comprising:
a job arrangement unit which arranges a plurality of jobs in order of priority; and
a job management unit which determines whether respective operations that are performed as the jobs are executed overlap one another and transmits the determination result to the job request expectation unit.

9. The apparatus of claim 8, wherein the job request expectation unit determines that the request for the second job is expected if the first operation and the second operation overlap each other.

10. The apparatus of claim 7, wherein the operation delay unit delays the first operation if a deadline for the second operation is approaching.

11. A method of processing operations of a nonvolatile memory in order of priority, the method comprising:
calculating the time remaining until a deadline for a second job if the second job with a higher priority than a first job is requested while a first operation is performed as the first job is executed;
calculating a remaining operation time of the first operation and a remaining execution time of the second job; and
determining whether to stop the first operation by comparing the time calculated by the first time calculation unit and the time calculated by the second time calculation unit.

12. The method of claim 11, further comprising comparing the time remaining until the deadline for the second job with the remaining operation time of the first operation and the remaining execution time of the second job.

13. The method of claim 12, wherein, if it is determined that the time remaining until the deadline for the second job is greater than a sum of the remaining operation time and the remaining execution time, the determining of whether to stop the first operation comprises performing a second operation as the second job is executed after completing the first operation.

14. The method of claim 13, wherein the determining of whether to stop the first operation comprises delaying the second operation until the first operation is completed.

15. The method of claim 12, wherein, if it is determined that the time remaining until the deadline for the second job is less than the sum of the remaining operation time and the remaining execution time, the determining of whether to stop the first operation comprises stopping the first operation and performing the second operation as the second job is executed.

16. The method of claim 15, wherein the determining of whether to stop the first operation comprises resuming the stopped first operation after the second operation is completed.

17. A method of processing operations of a nonvolatile memory in order of priority, the method comprising:
determining whether a request for a second job with a higher priority than a first job is expected while a first operation is performed as the first job is executed;
delaying the first operation and performing a second operation as the second job is executed if it is determined that the request for the second job is expected; and
performing the delayed first operation after the second operation is completed.

18. The method of claim 17, further comprising:
arranging a plurality of jobs in order of priority; and
determining whether respective operations that are performed as the jobs are executed overlap one another.

19. The method of claim 18, wherein the determining of whether the request for the second job is expected comprises determining that the request for the second job is expected when the first operation and the second operation overlap each other.

20. The method of claim 17, wherein the delaying of the first operation comprises delaying the first operation if a deadline for the second operation is approaching.
